(19) United States
(12) Patent Application Publication
(10) Pub. No.: US 2019/0248373 A1
(43) Pub. Date: Aug. 15, 2019

(54) MOTOR VEHICLE HAVING IMPROVED GEAR CHANGE QUALITY

(71) Applicant: Ford Global Technologies, LLC, Dearborn, MI (US)

(72) Inventor: Dennis Witt, Chelmsford (GB)

(21) Appl. No.: 16/262,810

(22) Filed: Jan. 30, 2019

(30) Foreign Application Priority Data
Feb. 13, 2018 (GB) 1802296.2

(51) Int. Cl. B60W 30/19

(52) U.S. Cl. CPC B60W 30/19; B60W 2710/305; B60W 2510/1005; B60W 2510/0638; B60W 2510/0208

(57) ABSTRACT

A motor vehicle is disclosed having an engine driving a multi-speed gearbox via a friction clutch. The engine is arranged to drive a number of electrically controllable loads the level of load applied by each of which to the engine is controlled by an electronic controller in response to a number of inputs. When the inputs indicate that an upshift of the gearbox is to take place the electronic controller is arranged to increase the loads applied by the electrically controllable loads to the engine and when the inputs indicate that a downshift of the gearbox is to take place the electronic controller is arranged to decrease the loads applied by the electrically controllable loads to the engine thereby improving the quality of the gear change irrespective of whether it is an upshift or a downshift.

### CROSS REFERENCE TO RELATED APPLICATION

This application claims priority to Great Britain Patent Application No. 1802296.2, filed Feb. 13, 2018. The entire contents of the above-listed application are hereby incorporated by reference in their entirety for all purposes.

### FIELD

The present disclosure relates to motor vehicles and, in particular, to a motor vehicle having a combustion engine driving a multi-speed manual gearbox via a manually controlled friction clutch and adjustable external loads.

### BACKGROUND

There is an ongoing need to improve the refinement of motor vehicles having internal combustion engines and one way of improving refinement is to reduce vibrations generated by fluctuations in engine rotational speed by increasing the inertia of the flywheel of such an engine.

However, the use of a flywheel of high inertia is disadvantageous during a change in ratio of an associated gearbox “a gear change” as the high inertia reduces the rate at which the engine can slow down or speed up. This slower response can result in a slower gear change or a large speed mismatch between the engine and an input shaft of the gearbox when the clutch is re-engaged at the end of the gear change which can result in unacceptable transmission jerk.

It is an object of the present disclosure to provide a motor vehicle in which one or more external loads applied to the engine are adjusted during a gear change to improve the quality of the gear change.

### SUMMARY

According to a first aspect of the present disclosure there is provided a motor vehicle having a combustion engine including a flywheel, a multi-speed gearbox driveably connectable to the combustion engine by a friction clutch, at least one electrically controllable load directly driven by the combustion engine, an electronic controller operatively connected to the at least one electrically controllable load, a first input to the electronic controller indicative of when a gear change event is predicted to occur and a second input to the electronic controller indicative of the type of gear change event predicted to occur wherein the electronic controller is arranged to increase the load applied by the at least one electrically controllable load during a gear change in which the friction clutch is disengaged from a normal load level required to meet a current need if the type of gear change predicted is an upshift and is further arranged to decrease the load applied by the at least one electrically controllable load during a gear shift from the normal load level if the type of gear change predicted is a downshift and is further arranged when the friction clutch is engaged and the gear change event ends to restore the at least one electrically controllable load to the normal load level.

Increasing the load during a gear change may comprise increasing the load applied to the combustion engine by the at least one electrically controllable load from the normal level to the maximum load that can be applied by the at least one electrically controllable load to the combustion engine.

Decreasing the load during a gear change may comprise decreasing the load applied to the combustion engine by the at least one electrically controllable load from the normal level to the minimum load that can be applied by the at least one electrically controllable load to the combustion engine.

The at least one electrically controllable load may be a variable displacement oil pump and increasing the load applied to the combustion engine may comprise increasing the displacement of the oil pump.

The displacement of the variable displacement oil pump may be increased a maximum flow state.

The at least one electrically controllable load may be a variable displacement oil pump and decreasing the load applied to the combustion engine may comprise reducing the displacement of the oil pump.

The displacement of the variable displacement oil pump may be reduced to a minimum flow state.

The at least one electrically controllable load may be a variable output engine coolant pump and increasing the load applied to the combustion engine may comprise increasing the output from the coolant pump.

The output from the variable output engine coolant pump may be increased to a maximum flow state.

The at least one electrically controllable load may be a variable output engine coolant pump and decreasing the load applied to the combustion engine may comprise decreasing the output from the engine coolant pump.

The output from the variable output engine coolant pump may be reduced to a minimum flow state.

The at least one electrically controllable load may be an air conditioner pump and increasing the load applied to the combustion engine may comprise engaging the air conditioner compressor.

The at least one electrically controllable load may be an air conditioner pump and decreasing the load applied to the combustion engine may comprise dis-engaging the air conditioner compressor.

The at least one electrically controllable load may be a fuel pump and increasing the load applied to the combustion engine comprises adjusting the fuel pump to increase fuel rail pressure.

The fuel pump may be adjusted to increase fuel rail pressure to a maximum operating pressure.

The at least one electrically controllable load may be a fuel pump and decreasing the load applied to the combustion engine comprises adjusting the fuel pump to reduce fuel rail pressure. The fuel pump may be adjusted to reduce fuel rail pressure to a minimum operating pressure.

The at least one electrically controllable load may be an electrical generator and increasing the load applied to the combustion engine may comprise increasing an electrical load applied to the electrical generator so as to increase the load applied by the electrical generator to the combustion engine.

The at least one electrically controllable load may be an electrical generator and decreasing the load applied to the combustion engine may comprise disconnecting any electrical loads connected to the electrical generator so as to decrease to a minimum the load applied by the electrical generator to the combustion engine.

The at least one electrically controllable load may be at least two electrically controllable loads chosen from a variable displacement oil pump, a variable output engine coolant pump, an air conditioner pump, a fuel pump and an electrical generator.

The first input to the electronic controller may be an output from a sensor used to indicate the engagement state of the clutch. The second input to the electronic controller may be an input indicative of engine speed.

If engine speed is indicated as increasing then this may be used as a prediction that the gear change will be an upshift and if engine speed is indicated as decreasing then this may be used as a prediction that the gear change will be a downshift.

According to a second aspect of the present disclosure there is provided a method of controlling the operation of a motor vehicle during a gear change of a multi-speed transmission driven via a friction clutch by an engine forming part of the motor vehicle wherein the method comprises checking whether a gear change event in which the friction clutch is disengaged is predicted to occur and, if a gear change event is predicted to occur, establishing the type of gear change event predicted to occur and, if the type of gear change predicted to occur is an upshift, increasing the load applied by at least one electrically controllable load directly driven by the engine during the gear change from a normal load level required to meet a current need and, if the type of gear change expected to occur is a downshift, decreasing the load applied by the at least one electrically controllable load driven by the engine during the gear shift from the normal load level and, when the friction clutch is engaged and the gear change event ends, restoring the at least one electrically controllable load to a normal load level.

Increasing the load applied to the combustion engine by the at least one electrically controllable load may comprise increasing the load from the normal load level to a maximum load level for the duration of the gear change event and decreasing the load during the gear change may comprise decreasing the load applied to the combustion engine by the at least one electrically controllable load from the normal load level to a minimum load level for the duration of the gear change event.

### BRIEF DESCRIPTION OF THE DRAWINGS

The invention will now be described by way of example with reference to the accompanying drawing of which:

FIG. 1 is a schematic diagram of a motor vehicle in accordance with a first aspect of the present disclosure; and

FIG. 2 is a high level flow chart showing a method of controlling a motor vehicle during a gear change event in accordance with a second aspect of the present disclosure.

### DETAILED DESCRIPTION

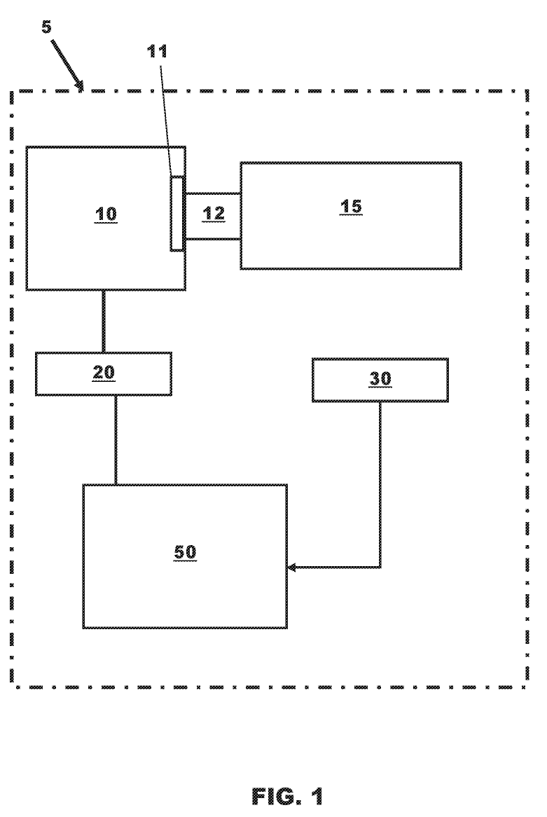

FIG. 1 shows an example configuration with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

With particular reference to FIG. 1 there is shown a motor vehicle 5 having a combustion engine 10 including a flywheel 11, a multi-speed gearbox 15 driveably connectable to the combustion engine 10 by a friction clutch 12, one or more electrically controllable loads 20 driven by the combustion engine 10 and an electronic controller 50 operatively connected to each electrically controllable load 20 to vary the load applied by each of the electrically controllable loads 20 to the engine 10.

The control methods and routines disclosed herein to may be stored as executable instructions in non-transitory memory and may be carried out by the control system including the controller in combination with the various sensors, actuators, and other engine hardware. For example, the controller may employ engine actuators of the engine system, such as those of electrically controllable loads 20, to adjust engine operation, according to the methods described below.

It will be appreciated that, although the electronic controller 50 is shown in FIG. 1 as a single unit, the electrical controller 50 could alternatively comprise of a number of separate controllers that are arranged to co-operate in order to produce the desired effect. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. For example, the electronic controller 50 is arranged to receive a number of inputs 30 which are used to control the level of the load applied to the combustion engine 10 by each of the electrically controllable loads 20 at least during a gear change event. The inputs 30 include a first input indicative of when a gear change event is predicted to occur and a second input indicative of the type of gear change event predicted to occur. Such inputs may, for example, be in the form of outputs from one or more sensors. In some aspects, such sensors may be in communication with one or more actuators located on one or more parts of the vehicle.

The first input to the electronic controller 50 is any suitable input from which it can be deduced that a gear change is about to occur.

For example, the first input can be an output from a sensor used to indicate the engagement state of the friction clutch 12 in combination with an indication that the motor vehicle 5 is moving. It will be appreciated that if the friction clutch 12 is placed in a disengaged state while the motor vehicle 5 is moving this can be used to predict that a gear change is about to occur.

It will be appreciated that other means could be used to provide the first input such as, for example and without limitation, a sensor associated with a knob on a gear lever used to change gear. When pressure is applied to the gear knob, the gear knob sensor is operable to provide an output to the electronic controller 50 indicative that a gear change is predicted to occur.

The second input to the electronic controller 50 can be any suitable input from which the type of gear change can be deduced.

For example, the second input can be an input indicative of engine speed. It will be appreciated that if the rotational speed of the combustion engine 10 is increasing immediately prior to the start of a gear change event then the probability is that the gear change event will be an upshift into a higher gear.

Similarly, if the rotational speed of the combustion engine 10 is decreasing immediately prior to the start of a gear change event then the probability is that the gear change event will be a downshift into a lower gear.

It will be appreciated that other techniques can be used to predict the type of gear change and that the present disclosure is not limited to the use of engine speed. For example, in UK patent GB-2,991,940 a system and method for predicting next to be engaged gear is disclosed which could be used to provide the second input.

Based upon the first and second inputs received by the electronic controller 50, the electronic controller 50 is arranged to increase the load applied by one or more of the electrically controllable loads 20 during a gear change if the type of gear change predicted based upon the second input is an upshift and is further arranged to decrease the load applied by one or more of the electrically controllable loads 20 during a gear change if the type of gear change predicted based upon the second input is a downshift.

When the first input indicates that the gear change event has ended the electronic controller 50 is arranged to restore any electrically controllable load 20 adjusted during the gear change event back to a normal load level required to meet a current need for that electrically controllable load.

The amount a load is increased is preferably the maximum that it can be increased even if that would temporarily affect the function that it is designed to perform. Therefore during a gear change event the respective electrically controllable load 20 will be controlled by the electronic controller 50 to increase the load applied to the combustion engine 10 by that electrically controllable load 20 from its normal level to the maximum load that can be applied by that electrically controllable load 20 to the combustion engine 10.

The amount a load is reduced is preferably the maximum that it can be reduced even if that would temporarily affect the function that it is designed to perform. Therefore, during a gear change event, the respective electrically controllable load 20 will be controlled by the electronic controller 50 to reduce the load applied to the combustion engine 10 by that electrically controllable load 20 from its normal level to the minimum load that can be applied by that electrically controllable load 20 to the combustion engine 10.

It will be appreciated that in some embodiments only a single electrically controllable load is driven by the combustion engine 10 but in other embodiments several electrically controllable loads 20 will be driven by the engine 10

Non-limiting examples of electrically controllable loads are a variable displacement oil pump, a variable output engine coolant pump, an air conditioner pump, a fuel pump and an electrical generator.

If the electrically controllable load is a variable displacement oil pump, then increasing the load applied to the combustion engine 10 will comprise adjusting the displacement of the oil pump to a maximum flow state and decreasing the load applied to the combustion engine 10 will comprise adjusting the displacement of the oil pump to a minimum flow state.

If the electrically controllable load is a variable output engine coolant pump, then increasing the load applied to the combustion engine 10 will comprise adjusting the output from the coolant pump to a maximum flow state and decreasing the load applied to the combustion engine will comprise adjusting the output from the engine coolant pump to a minimum flow state.

If the electrically controllable load is an air conditioner pump, then increasing the load applied to the combustion engine 10 will comprise engaging the air conditioner compressor and decreasing the load applied to the combustion engine 10 will comprise dis-engaging the air conditioner compressor.

It will be appreciated that typically air conditioner compressors are driven by an engine via a clutch and so engaging the air conditioning compressor will comprise engaging the clutch used to drive the air conditioning compressor and dis-engaging the air conditioning compressor will comprise dis-engaging the clutch used to drive the air conditioning compressor.

If the electrically controllable load is a fuel pump, then increasing the load applied to the combustion engine will comprise adjusting the fuel pump to increase fuel rail pressure to a maximum operating pressure and decreasing the load applied to the combustion engine 10 will comprise adjusting the fuel pump to reduce fuel rail pressure to a minimum operating pressure.

If the electrically controllable load is an electrical generator, then increasing the load applied to the combustion engine 10 will comprise increasing the electrical load applied to the electrical generator so as to increase the load it applies to the combustion engine and decreasing the load applied to the combustion engine 10 will comprise disconnecting any electrical loads connected to the electrical generator so as to reduce to a minimum the load applied by the electrical generator to the combustion engine 10.

The electrical load applied to the electrical generator could be any suitable load such as, for example, charging a battery, powering a rear screen heater, powering a seat heater or any other suitable device controllable by the electronic controller 50 requiring a source of electrical power.

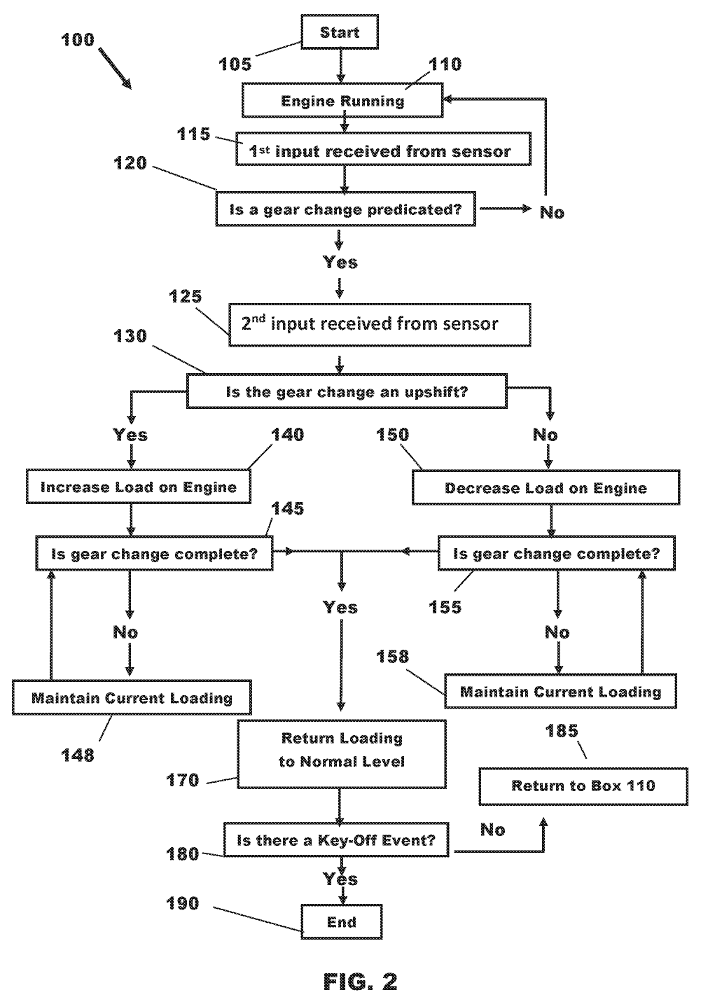

With reference to FIG. 2 there is shown a method 100 of controlling the operation of a motor vehicle during a gear change of a multi-speed transmission driven by an engine forming part of the motor vehicle.

The method 100 starts in box 105 which could be a Key-on event and then advances to box 110 where the engine of the motor vehicle such as the motor vehicle 5 is running.

From box 110 the method 100 advances to box 115 where a first input is received by the electronic controller. The electronic controller determines at 120 whether a gear change is predicted to occur. If a gear change is not predicted to occur, the method 100 returns to box 110 and will cycle around boxes 110, 115 and 120 until either a gear change is predicted to occur or there is a Key-off event. If there is a Key-off event then the method 100 will end and, although not shown in FIG. 2, the method 100 will advance to box 190.

If when checked in box 120 a gear change is predicted to occur then the method 100 advances to box 125 to receive the second input. The electronic controller determines at 130 the type of gear change event predicted to occur. In the case of this example this is done by checking in box 130 to see whether the predicted gear change is an upshift but it will be appreciated that the check in box 130 could alternatively be a check to see whether the predicted gear change is a downshift. In either case a determination is made as to whether the predicted gear change is an upshift or a downshift.

If the type of gear change predicted to occur is an upshift, the method 100 advances from box 130 to box 140 where one or more electrically controllable loads driven by the engine are controlled to increase the load they apply to the engine. Preferably, the or each load is increased to provide the maximum load possible.

The method 100 then advances from box 140 to box 145 to check whether the gear change is complete. This can be done in any suitable manner such as checking whether the clutch connecting the engine to the multi-speed gearbox is engaged.

If the gear change is not complete the method 100 advances to box 148 where the additional loading from the electrically controllable loads is maintained at the current high level and then returns to box 145 to check again whether the gear change is complete.

If when checked in box 145 the gear change is determined to be complete, then the method 100 advances from box 145 to box 170 where any of loads that have had their loading increased are returned to a normal level required to meet the current need for that load.

From box 170 the method 100 advances to box 180 to check whether there has been a Key-off event and if there has not the method 100 returns via box 185 to box 110. However, if there has been a Key-off event then the method 100 advances from box 180 to box 190 where it ends. It will be appreciated that at any time if there is a Key-off event then the method 100 will end. Returning to box 130, if it is determined that the gear change is predicted to be a downshift, then the method 100 advances from box 130 to box 150.

In box 150 one or more electrically controllable loads driven by the engine are controlled so as to decrease the load applied by the respective electrically controllable load. Preferably, the or each load is decreased to provide the minimum load possible.

The method 100 then advances from box 150 to box 155 to check whether the gear change is complete. As before, this can be done in any suitable manner such as checking whether the clutch connecting the engine to the multi-speed gearbox is engaged.

If the gear change is not complete, the method 100 advances to box 158 where the additional loading from the electrically controllable loads is maintained at the current level and then returns to box 155 to check again whether the gear change is complete.

If when checked in box 155 the gear change is determined to be complete, then the method 100 advances from box 155 to box 170 where any of loads that have had their loading increased are returned to a normal level required to meet the current need for that load.

From box 170 the method 100 advances to box 180 to check whether there has been a Key-off event and if there has not the method 100 returns via box 185 to box 110. However, if there has been a Key-off event then the method 100 advances from box 180 to box 190 where it ends.

Therefore, the method 100 is operable to increase the load applied to an engine by engine driven loads during an upshift in order to reduce the rotational speed of the engine more rapidly than would otherwise be the case thereby reducing the time taken to effect a gear change and reducing the energy that has to be dissipated by the clutch during synchronisation of engine speed with gearbox input speed.

In the case of a downshift the method 100 is operable to adjust the load applied to the engine by engine driven loads to reduce the level of these loads thereby enabling the rotational speed of the engine to be more easily increased to match the input speed of the gearbox.

The effect of these adjustment of load applied to the engine is to improve the quality of a gear change irrespective of whether it is an upshift or a downshift.

One of the non-obvious features of the present disclosure is that loads applied to the engine by engine driven components such as a variable displacement oil pump, a variable output engine coolant pump, an air conditioner pump, a fuel pump and an electrical generator can be allowed to be operated outside a normal operational range because the length of time that they have to be so operated is very short namely only the length of time that it takes to change from one gear ratio to another gear ratio.

It will be appreciated that each electrically controllable load driven by the combustion engine is a load that acts directly upon the engine. That is to say, it is a load driven by the engine via one of a chain drive, a belt drive, a gear drive or a direct drive connection (with or without a clutch) to a rotating part of the engine.

It will be appreciated by those skilled in the art that although the present disclosure has been described by way of example with reference to one or more embodiments it is not limited to the disclosed embodiments and that alternative embodiments could be constructed without departing from the scope as defined by the appended claims.

1. A motor vehicle having a combustion engine comprising:
a flywheel,
a multi-speed gearbox driveably connectable to the combustion engine by a friction clutch,
at least one electrically controllable load directly driven by the combustion engine,
an electronic controller operatively connected to the at least one electrically controllable load,
a first input to the electronic controller indicative of when a gear change event is predicted to occur, and
a second input to the electronic controller indicative of the type of gear change event predicted to occur,
wherein the electronic controller is arranged to increase the load applied by the at least one electrically controllable load during a gear change in which the friction clutch is disengaged from a normal load level required to meet a current need if the type of gear change predicted is an upshift and is further arranged to decrease the load applied by the at least one electrically controllable load during a gear shift from the normal load level if the type of gear change predicted is a downshift and is further arranged when the friction clutch is engaged and the gear change event ends to restore the at least one electrically controllable load to the normal load level.

2. The motor vehicle as claimed in claim 1, wherein increasing the load during a gear change comprises increasing the load applied to the combustion engine by the at least one electrically controllable load from the normal level to the maximum load that can be applied by the at least one electrically controllable load to the combustion engine.

3. The motor vehicle as claimed in claim 1, wherein decreasing the load during a gear change comprises decreasing the load applied to the combustion engine by the at least one electrically controllable load from the normal level to the minimum load that can be applied by the at least one electrically controllable load to the combustion engine.

4. The motor vehicle as claimed in claim 1, wherein the at least one electrically controllable load is a variable displacement oil pump, variable output engine coolant pump, air conditioner pump, an electric generator or a fuel pump.

5. The motor vehicle as claimed in claim 4, wherein the at least one electrically controllable load is a variable displacement oil pump and increasing the load applied to the combustion engine comprises increasing the displacement of the oil pump.

6. The motor vehicle as claimed in claim 4, wherein the at least one electrically controllable load is a variable displacement oil pump and decreasing the load applied to the combustion engine comprises reducing the displacement of the oil pump.

7. The motor vehicle as claimed in claim 4, wherein the at least one electrically controllable load is a variable output engine coolant pump and increasing the load applied to the combustion engine comprises increasing the output from the coolant pump.

8. A motor vehicle as claimed in claim 4, wherein the at least one electrically controllable load is a variable output engine coolant pump and decreasing the load applied to the combustion engine comprises decreasing the output from the engine coolant pump.

9. The motor vehicle as claimed in claim 1, wherein the at least one electrically controllable load is at least two electrically controllable loads chosen from a variable displacement oil pump, a variable output engine coolant pump, an air conditioner pump, a fuel pump and an electrical generator.

10. The motor vehicle as claimed in claim 1, wherein the first input to the electronic controller is an output from a sensor used to indicate the engagement state of the clutch.

11. The motor vehicle as claimed in claim 1, wherein the second input to the electronic controller is an input indicative of engine speed.

12. The motor vehicle as claimed in claim 11, wherein the second input to the electronic controller is an indication of an increase in engine speed wherein an increase in engine speed indicates that the gear change will be an upshift.

13. The motor vehicle as claimed in claim 12, wherein the second input to the electronic controller is an indication of a decrease in engine speed, wherein a decrease in engine speed indicates that the gear change will be a downshift.

14. A method of controlling the operation of a motor vehicle during a gear change of a multi-speed transmission driven via a friction clutch by an engine forming part of the motor vehicle wherein the method comprises:
checking whether a gear change event in which the friction clutch is disengaged is predicted to occur and, if a gear change event is predicted to occur, establishing the type of gear change event predicted to occur and, if the type of gear change predicted to occur is an upshift, increasing the load applied by at least one electrically controllable load directly driven by the engine during the gear change from a normal load level required to meet a current need and, if the type of gear change expected to occur is a downshift, decreasing the load applied by the at least one electrically controllable load driven by the engine during the gear shift from the normal load level and, when the friction clutch is engaged and the gear change event ends, restoring the at least one electrically controllable load to a normal load level.

15. The method as claimed in claim 14, wherein increasing the load applied to the combustion engine by the at least one electrically controllable load comprises increasing the load from the normal load level to a maximum load level for the duration of the gear change event and decreasing the load during the gear change comprises decreasing the load applied to the combustion engine by the at least one electrically controllable load from the normal load level to a minimum load level for the duration of the gear change event.

16. An engine method comprising:
increasing at least one electrically controllable load during a gear change responsive to a predicted gear upshift in which a friction clutch is disengaged, and
decreasing the at least one electrically controllable load during a gear shift responsive to a predicted gear downshift, wherein the friction clutch is engaged and the gear change event ends to restore the at least one electrically controllable load to the normal load level.

17. The method of claim 16, wherein increasing the electrically controllable load comprises increasing displacement of a variable displacement oil pump and decreasing the electrically controllable load comprises reducing the displacement of the variable displacement oil pump.

18. The method of claim 17, wherein the displacement of the variable displacement oil pump is increased to a maximum flow state.

19. The method of claim 16, wherein increasing the electrically controllable load comprises increasing the output from a variable output engine coolant pump and decreasing the electrically controllable load comprises decreasing the output from the variable engine coolant pump.

20. The method of claim 16, wherein increasing or decreasing the electrically controllable load is in response to a first input from a first sensor of an indication of a gear change event and a second input from a second sensor that the gear change event is an upshift or a downshift.
